(19) United States
(12) Patent Application Publication
(10) Pub. No.: US 2007/0283383 A1
(43) Pub. Date: Dec. 6, 2007

(54) Digital television receiver and method for processing broadcast signal

(76) Inventor: Kwan Suk Kim, Seoul (KR)

Correspondence Address: MCKENNA LONG & ALDRIDGE LLP;Song K. Jung, 1900 K Street, N.W., Washington, DC, 20006, US

(21) Appl. No.: 11/806,237

(22) Filed: May 30, 2007

(30) Foreign Application Priority Data
May 30, 2006 (KR) 10-2006-0049052

(51) Int. Cl. H04N 7/025; H04N 7/16; H04N 7/10

(52) U.S. Cl. 725/32; 725/135; 725/34

(57) ABSTRACT

A broadcast receiver and a method for processing a broadcast signal including advertisement program information of a PSIP are disclosed. The broadcast receiver analyzes the advertisement program information contained in the broadcast signal, and provides a user with the analyzed result, such that it can provide the user with advertisement program information configured in the form of an electronic program guide (EPG). The broadcast receiver user can record or exclude only the advertisement program selected by the user, or can record only the main broadcast program other than the advertisement program inserted into the single main broadcast program (i.e., commercial in program or event), such that the user can freely manage the advertisement program according to his or her desired scheme.

This application claims the benefit of Korean Patent Application No. 10-2006-0049052, filed on May 30, 2006, which is hereby incorporated by reference as if fully set forth herein.

### BACKGROUND OF THE INVENTION

1. Field of the Disclosure

The present disclosure relates to a digital television (DTV) receiver and a method for processing a broadcast signal.

2. Discussion of the Related Art

Typically, a Program and System Information Protocol (PSIP) is an Advanced Television System Committee (ATSC) standard for terrestrial and cable digital broadcast technologies.

The PSIP transmits broadcast signals encoded by an MPEG-2 system to a broadcast receiver. A digital TV performs parsing of the encoded broadcast signals, and displays a variety of programs.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc. There are a variety of tables, for example, a Master Guide Table (MGT), a Terrestrial Virtual Channel Table (TVCT), a Cable Virtual Channel Table (CVCT), a System Time Table (STT), a Rating Region Table (RRT), an Event Information Table (EIT), and an Extended Text Table (ETT), etc. Conventionally, the PSIP can provide users with a variety of information associated with each of numerous events via an Electronic Program Guide (EPG) service, etc.

However, the term “event” of the above-mentioned PSIP is indicative of a broadcast program unit. Namely, the event is a collection of associated program elements that have a common timeline for a defined period. For example, if there are broadcast programs (i.e., drama1, movie2, and news1), the broadcast programs (i.e., drama1, movie2, and news1) configure a single event.

The EPG is indicative of a program schedule including program- and summary-data of individual channels. The EPG serves as an electronic guide equal to a printed television (TV) program guide, and is generally controlled by a remote controller. Besides, the EPG may order a pay-per-view program, may search for programs for each theme or category, and may record video data, etc.

However, the above-mentioned conventional digital broadcast technology has the following disadvantages.

Firstly, the conventional digital broadcast technology does not provide a user with information about an advertisement program inserted between a current main broadcast program and the next main broadcast program. Therefore, the user has difficulty in independently managing the advertisement program.

Secondly, the conventional digital broadcast technology does not provide the user with information of an commercials in program, such that the user also has difficulty in independently managing the commercials in program. For example, if a reserved recording function for the main broadcast program including the commercials is established, the commercials in program undesired by the user may be unavoidably recorded along with the above-mentioned main broadcast program.

### SUMMARY OF THE INVENTION

Accordingly, the present disclosure is directed to a digital television receiver and a method for processing the same that substantially obviate one or more problems due to limitations and disadvantages of the related art.

An object of the present disclosure is to provide a method for transmitting a broadcast signal including advertisement program information for use in a digital broadcasting, and a broadcast receiver for processing the same.

Another object of the present disclosure is to provide a method for processing a broadcast signal including advertisement program information, and a broadcast receiver for processing the same, which may selectively record only a specific broadcast advertisement program or prevent only the specific broadcast advertisement program from being recorded, such that a user can selectively manage the advertisement program.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of processing a digital broadcast signal in a digital television (DTV) receiver, the method comprising: receiving a broadcast signal which includes an event information table (EIT) that defines at least one advertisement program located between events as a separate event and includes information of the advertisement program; and displaying the information of the advertisement program on a screen.

In another aspect of the present disclosure, there is provided A method of processing a digital broadcast signal in a digital television (DTV) receiver, the method comprising: receiving a broadcast signal which includes an event information table (EIT) containing information for an event and information for at least one advertisement program in the middle of the event; and displaying the information of the advertisement program on a screen.

In yet another aspect of the present disclosure, there is provided a digital television (DTV) receiver comprising: a demultiplexer for demultiplexing an event information table (EIT) that defines at least one advertisement program located between events as a separate event and includes information of the advertisement program; a parser for parsing the demultiplexed information, and decoding the parsed information; and a controller for controlling the information of the advertisement program to be displayed on a screen.

In yet another aspect of the present disclosure, there is provided A digital television (DTV) receiver comprising: a demultiplexer for demultiplexing an event information table (EIT) containing information for an event and information for at least one advertisement program in the middle of the event; a parser for parsing the demultiplexed information, and decoding the parsed information; and a controller for controlling the information of the advertisement program to be displayed on a screen.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 exemplarily shows a bit stream syntax associated with an Event Information Table (EIT);

FIG. 2 exemplarily shows an advertisement_descriptor syntax;

FIG. 3 exemplarily shows an Event Information Table (EIT) including a plurality of events with the lapse of time according to an embodiment;

FIG. 4 exemplarily shows an Event Information Table (EIT) including a plurality of events with the lapse of time according to another embodiment;

FIG. 5 is a block diagram illustrating a broadcast receiver for receiving/processing an Event Information Table (EIT) and an advertisement_descriptor;

FIG. 6 is a flow chart illustrating a method for receiving/processing an Event Information Table (EIT) and an advertisement_descriptor; and

FIG. 7 shows an exemplary screen image on which a reserved recording function for a broadcast receiver is established.

### DETAILED DESCRIPTION OF THE INVENTION

Reference will now be made in detail to the embodiments of the present disclosure, examples of which are illustrated in the accompanying drawings. Wherever possible, the same reference numbers will be used throughout the drawings to refer to the same or like parts.

For the convenience of description and better understanding of the present disclosure, the present disclosure will sequentially describe a method for constructing an EIT syntax and an advertisement descriptor, an application example of the EIT based on the relationship between a main broadcast program and an advertisement program, a broadcast receiver for receiving/processing the Event Information Table (EIT), and a method for processing a broadcast signal.

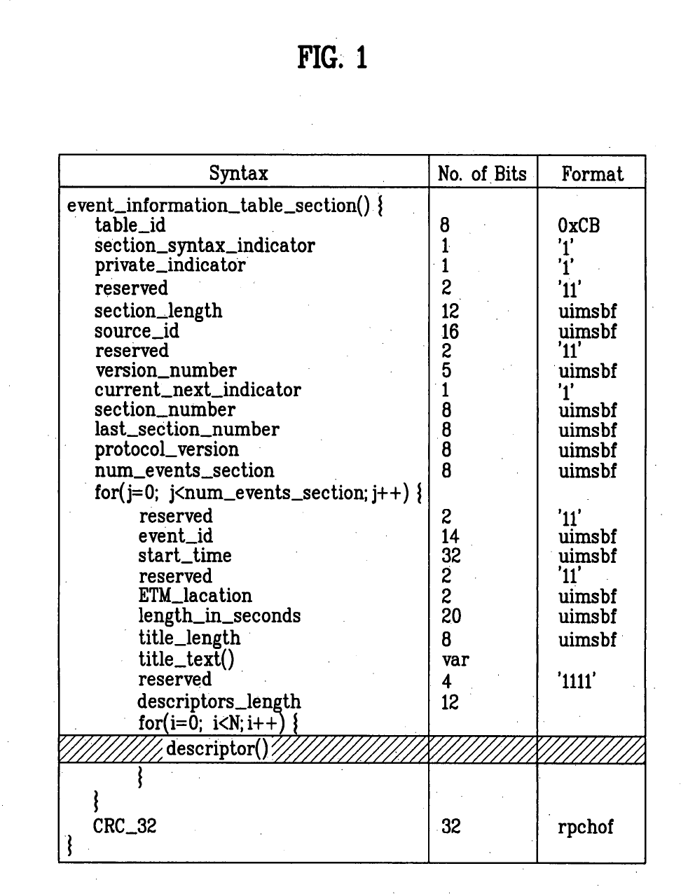

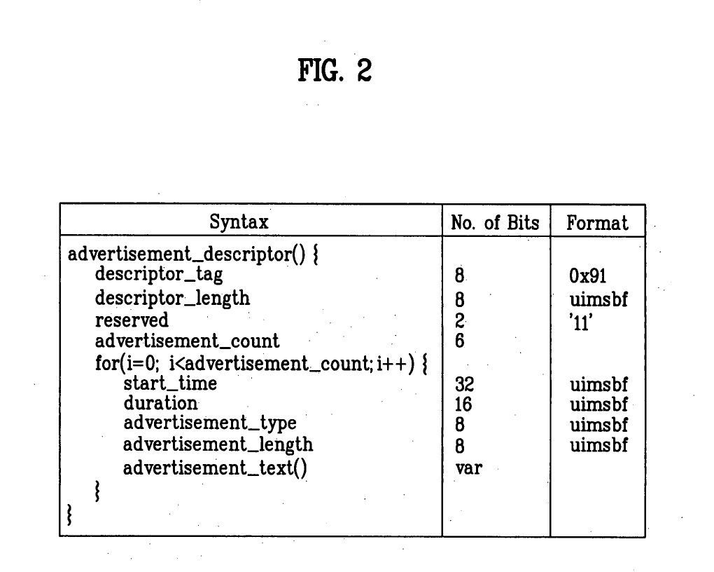

FIG. 1 exemplarily shows a bit stream syntax associated with an Event Information Table (EIT). FIG. 2 exemplarily shows an advertisement_descriptor syntax. A method for constructing the Event Information Table (EIT) syntax and the advertisement_descriptor according to the present disclosure will hereinafter be described with reference to FIGS. 1 and 2.

The event information table (EIT) is one of tables of the PSIP including a title and a start time of at least one event of a single virtual channel. For example, if a drama1 exists, a movie2 exists, and a news1 exists, each broadcast program configures a single event.

The Event Information Table (EIT) contains information (titles, start times, etc.) for events on defined virtual channels. The EIT shall be used to provide information for virtual channels. Up to 128 EITs may be transmitted and each of them is referred to as EIT-k (where k=0, 1, . . . 127). Each EIT-k can have multiple instances, each of which contains information for one virtual channel, and each of which is identified by the combination of “table_id” and “source_id” fields.

As can be seen from FIG. 1, the EIT includes a plurality of fields. The “table_id” field is an 8-bit field which shall be set to 0xCB, identifying this section as belonging to the Event Information Table. The “section_syntax_indicator” field includes a single bit, and is set to the value of ‘1’. In this case, a corresponding section follows generic section syntax beyond the “section_length” field. The “private_indicator” field is a 1-bit field, and is set to the value of “1”.

In association with the present disclosure, the most important part is a descriptor defined under the “for-loop” syntax, and other fields other than the descriptor will herein be omitted for the convenience of description. The present disclosure is characterized in that the event schedule descriptor of FIG. 2 is defined in the oblique-lined descriptor of FIG. 1.

As can be seen from FIG. 2, the “descriptor_tag” field includes identification information for allowing the descriptor to identify the advertisement descriptor.

The “descriptor_tag” field may be set to the value of “0x91”, however, it should be noted that the “0xC1” value is disclosed for only illustrative purposes, and other values may also be used as necessary. The “descriptor_length” field includes specific information for defining the length from the next field to the last field of the descriptor. For example, the “descriptor_length” field may be defined in byte units.

The “advertisement_count” field includes specific information indicating the number of advertisement programs contained in a corresponding event. Each advertisement program contained in the corresponding event will hereinafter be referred to as an advertisement entry. As many “for-loop” parts as the number of advertisement programs contained in the event is repeated.

The “start_time” field includes specific information for defining the start time of each advertisement program. The “duration” field includes specific information for defining a duration time of each advertisement program. Namely, the duration field includes information of a duration time of a corresponding advertisement entry.

The “advertisement_type” field includes specific information of category- or genre-information of a corresponding advertisement program. Namely, the “advertisement_type” field includes specific information of category- or genre-information of a corresponding advertisement entry.

For example, if the “advertisement_type” field has a specific value “0x0001”, this indicates that the corresponding advertisement program is a “food advertisement”. If the “advertisement_type” field has a specific value “0x0002”, this indicates that the corresponding advertisement program is a “clothing advertisement”. If the “advertisement_type” field has a specific value “0x0003”, this indicates that the corresponding advertisement program is a “vehicle advertisement”. If the “advertisement_type” field has a specific value “0x0004”, this indicates that the corresponding advertisement program is an “apartment advertisement” program.

The “advertisement_length” field includes length- or size-information of additional advertisement information of a corresponding advertisement program. The “advertisement_text” field indicates additional information of a corresponding advertisement program, and may be represented in the form of text.

As described above, a unique additional advertisement_descriptor may be assigned to each event, such that advertisement program information can be added to a single event, and the user can manage the above-mentioned program according to his or her desired scheme.

Particularly, the above-mentioned advertisement_descriptor is defined at the location of a descriptor contained in the Event Information Table (EIT), such that the user can pre-recognize not only information of a current advertisement program, but also information of the next advertisement program to be broadcast after the lapse of a predetermined period of time.

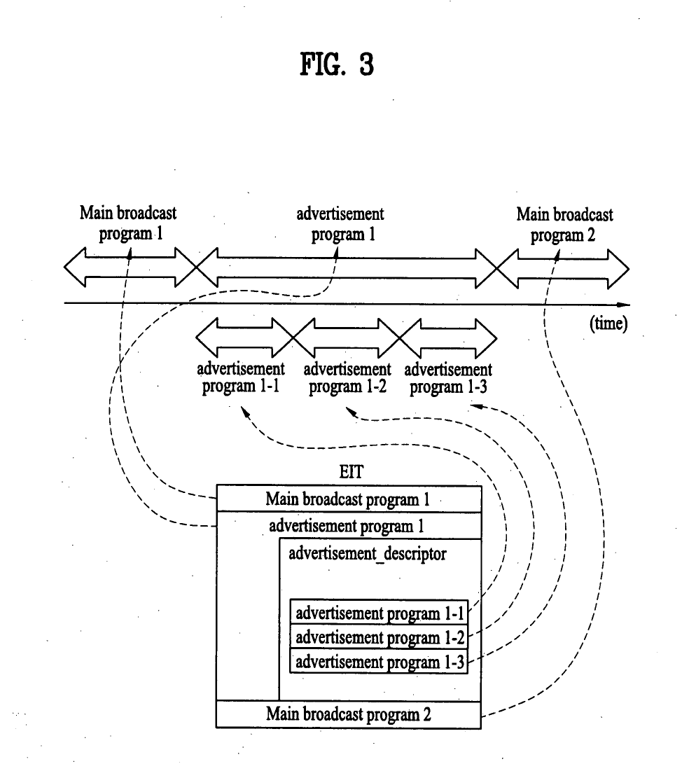

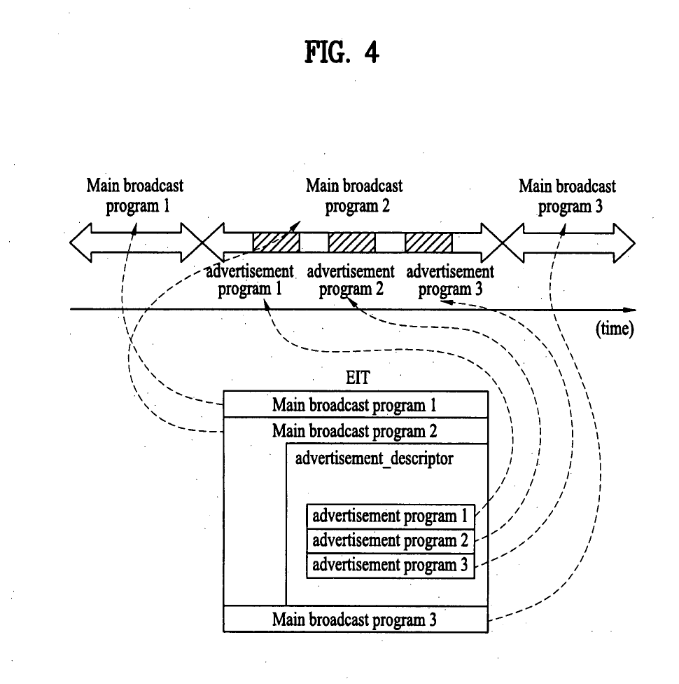

FIG. 3 exemplarily shows an Event Information Table (EIT) including a plurality of events with the lapse of time according to an embodiment. FIG. 4 exemplarily shows an Event Information Table (EIT) including a plurality of events with the lapse of time according to another embodiment. Application examples of the EIT including the above-mentioned advertisement_descriptor according to the location of the advertisement program will hereinafter be described with reference to FIGS. 3˜4 and FIGS. 1˜2.

Firstly, an exemplary EIT application acquired when an advertisement program is located between the main broadcast program and the next broadcast program (i.e., an advertisement program is located between the events) will be described with reference to FIG. 3.

A conventional PSIP does not define the advertisement program as an EIT event, and only the main broadcast program is defined as an EIT event. However, the present disclosure can define the advertisement program as the EIT event. In this case, the event ID (event_id) capable of identifying the above-mentioned advertisement program as an event must be additionally defined at the value of the “event—id” field shown in FIG. 1. In this way, the present disclosure is characterized in that the advertisement program is defined as the EIT event.

As can be seen from FIG. 3, it is assumed that a main broadcast program1, an advertisement program2, and a main broadcast program2 will be broadcast with the lapse of time over a specific virtual channel identified by the combination of the “table_id” field and the “source_id” field” of the EIT table. In this case, the main broadcast program 1, the advertisement program 1, and the main broadcast program 2 are considered to be an independent event contained in each EIT, such that unique event IDs (event_id) are assigned to the above-mentioned broadcast programs.

The advertisement program 1 includes an advertisement program 1-1, an advertisement program 1-2, and the advertisement program 1-3. Information of advertisement program 1-1, the advertisement program 1-2, and the advertisement program 1-3 is defined by the advertisement_descriptor contained in the advertisement program 1 event.

The advertisement program 1-1, the advertisement program 1-2, and the advertisement program 1-3 may also be defined by unique events, respectively. However, in this embodiment, considering the operation rapidity of the broadcast receiver and the data transmission efficiency, all the advertisement programs located between the main broadcast program and the next main broadcast program(i.e., between the events) are treated as a single event.

Secondly, as can be seen from FIG. 4, a second exemplary EIT application acquired when at least one advertisement program exists in a single main broadcast program(i.e., advertising in the middle of program or event) will hereinafter be described with reference to FIG. 4. Under the broadcast environment for occasionally inserting advertisement data into the main broadcast program.

As shown in FIG. 4, it is assumed that an advertisement program 1, an advertisement program 2, and an advertisement program 3 exist in the main broadcast program 2 over a specific virtual channel identified by the combination of the “table_id” field and the “source_id” field” of the EIT table.

In this case, differently from the above-mentioned first application example, there is no need to define the advertisement program inserted into the main broadcast program (i.e., commercial in program or event) as an EIT event. In other words, if the main broadcast program 2 is defined as a single event, information of the advertisement program 1, information of the advertisement program 2, and information of the advertisement program 3 can be defined by the advertisement_descriptor contained in the event of the main broadcast program 2.

Although the first application example and the second application example have been disclosed separately from each other, it should be noted that the first application example and the second application example may be combined to implement the concept of the present disclosure.

For example, provided that the advertisement program exists between the main broadcast program and the next main broadcast program(i.e., between the events), and the advertisement program inserted into the single main broadcast program (i.e., commercial in program or event), the above-mentioned first application example and the second application example may be combined with each other as necessary.

According to the above-mentioned present disclosure, the user can manage either the advertisement program located between the main broadcast program or the advertisement program inserted into the single main broadcast program (i.e., commercial in program or event), and can easily filter the advertisement using the above-mentioned information.

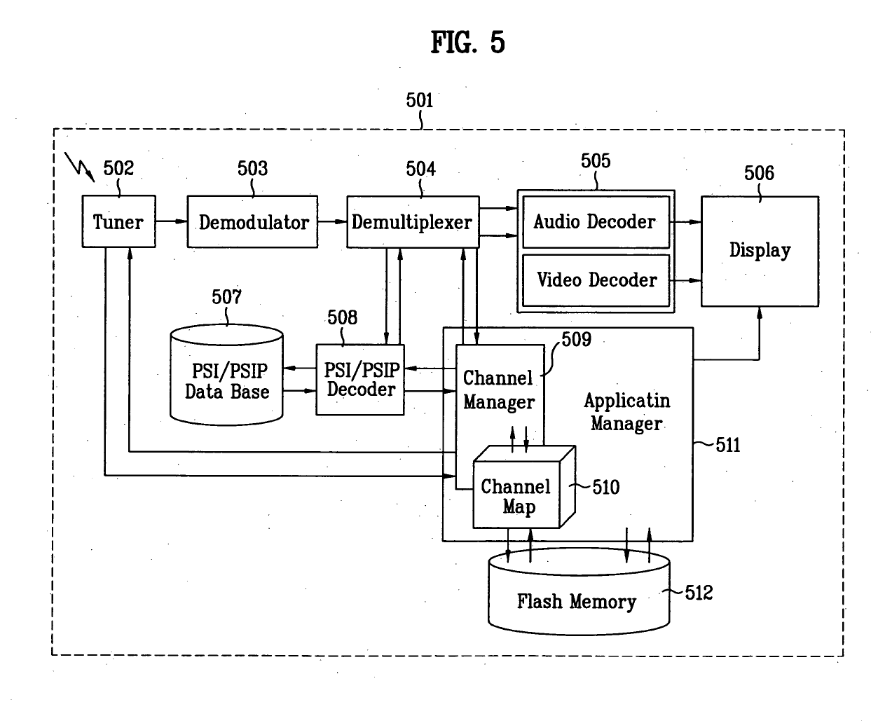

FIG. 5 is a block diagram illustrating a broadcast receiver for receiving/processing an Event Information Table (EIT) and an event schedule descriptor according to the present disclosure. The broadcast receiver for receiving/processing the EIT will hereinafter be described with reference to FIGS. 5 and 1˜4.

Referring to FIG. 5, the broadcast receiver 501 includes a tuner 502, a demodulator 503, a demultiplexer 504, an A/V decoder 505, a display 506, a PSI/PSIP database 507, a PSI/PSIP decoder 508, a channel manager 509, a channel map 510, an application controller (i.e., application & UI manager) 511, and a flash memory 512, etc. The broadcast receiver 501 may be set to a digital TV (DTV) capable of receiving digital broadcast data.

The tuner 502 can receive a digital broadcast signal including the PSI/PSIP (Program Specific Information /Program and System Information Protocol) table. Particularly, the PSI/PSIP table includes the EIT (Event Information Table). The tuner 502 can be controlled by the channel manager 509. The tuner 502 transmits the received digital broadcast signal to the channel manager 509.

The demodulator 503 demodulates the signal tuned by the tuner 502 into a VSB/EVSB (Vestigial Side Band/Enhanced Vestigial Side Band). The demultiplexer 504 demultiplexes the signal demodulated by the demodulator 503 into audio data, video data, and PSI/PSIP table data. The demultiplexing of the audio and video data can be controlled by the channel manager 509. The demultiplexing of the PSI/PSIP table data can be controlled by the PSI/PSIP decoder 508.

The demultiplexer 504 transmits the demultiplexed PSI/PSIP table to the PSI/PSIP decoder 508, and the demultiplexed audio and video data is transmitted to the A/V decoder 505. The A/V decoder 505 decodes the received audio and video data. The PSI/PSIP decoder 508 performs parsing of the PSI/PSIP section, reads the remaining actual section data which has not been section-filtered by the demultiplexer 504, and records the read data in the PSI/PSIP database 507.

The channel manager 509 transmits a request for receiving a channel-associated information table by referring to the channel map 510, and receives the response to the request. In this case, the PSI/PSIP decoder 508 controls the demultiplexing of the channel-associated information table, and transmits the A/V PID (Packet ID) list to the channel manager 509. The channel manager 509 controls the demultiplexer 504 using the transmitted A/V PID list, such that the A/V decoder 505 is controlled. The application controller 511 controls a Graphical User Interface (GUI) for displaying status information of the broadcast receiver system on the OSD (On Screen Display).

Particularly, according to the present disclosure, the demultiplexer 504 demultiplexes the EIT, and transmits the demultiplexed result to the PSI/PSIP decoder 508. The EIT (Event Information Table) according to the present disclosure can be readily understood by the above-mentioned embodiments. The PSI/PSIP decoder 508 detects the EIT, and decodes information of the advertisement program contained in a specific event. In this case, the above-mentioned specific event may be indicative of an event of the main broadcast program as shown in the embodiment of FIG. 4, or may be indicative of an event of the advertisement program as shown in the embodiment of FIG. 3.

There are a variety of advertisement program information, for example, start time, duration time, type, and additional information of the advertisement program. For example, the type of the advertisement program may be genre information capable of identifying individual advertisement programs. The additional information of the advertisement program may be a title of the advertisement, and a performer who appears in the advertisement.

The application manager 511 controls the display 506 by referring to the above-mentioned information, can display the advertisement program information contained in the specific event. In another embodiment, the advertisement program information can be acknowledged in the form of audio data with video data. Otherwise, the application manager 511 can output the above-mentioned advertisement program information in the form of only the audio data other than the video data.

In the meantime, if the user who has viewed the displayed screen image establishes a reserved recording function for only the specific advertisement program, the channel manager 509 controls the tuner 502 at a specific time, and the application manager 509 allows specific advertisement program desired by the user to be stored in a Hard Disc Drive (HDD) (not shown).

If the user who has viewed the displayed screen image establishes a specific function for recording only the main broadcast program other than the advertisement program inserted into the single main broadcast program (i.e., commercial in program or event), the application manager 509 controls only the main broadcast program to be stored in the HDD.

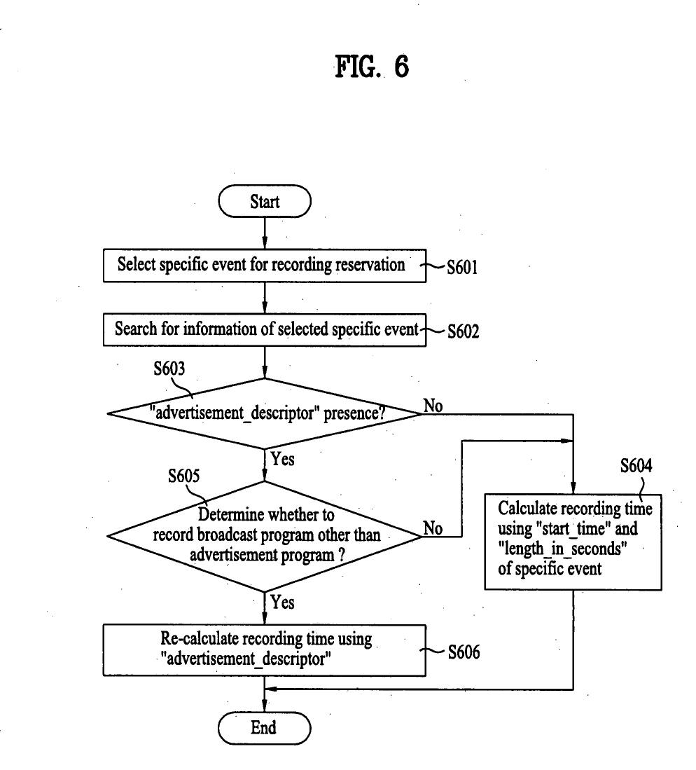

FIG. 5 is a flow chart illustrating a method for controlling the broadcast receiver capable of receiving/processing an event information table (EIT) and an advertisement_descriptor. FIG. 6 shows an exemplary screen image on which a reserved recording function of the broadcast receiver is established. A method for processing a broadcast signal according to the present disclosure will hereinafter be described with reference to FIGS. 6, 7, and 1˜5.

Referring to FIG. 6, a user selects a specific event for the reserved recording (also called a recording reservation) by referring to the electronic program guide (EPG) at step S601. The broadcast receiver searches for information of the selected specific event using the PSIP (Program and System Information Protocol) data at step S602. In more detail, The PSIP data is indicative of the EIT. The exemplary EIT is shown in FIGS. 1˜2.

The broadcast receiver determines the presence or absence of an advertisement_descriptor in the above-mentioned specific event information at step S603.

If it is determined that there is no advertisement_descriptor at step S603, the broadcast receiver calculates a recording time using the “start_time” field value and the “length_in_seconds” field value defined in the EIT of the specific event, and performs the recording function at a corresponding time at step S604.

Otherwise, if the presence of the event advertisement_descriptor is determined at step S603, the broadcast receiver determines whether a recording function for recording the main broadcast program other than the advertisement program inserted into the main broadcast program (i.e., commercial in program or event) is established at step S605.

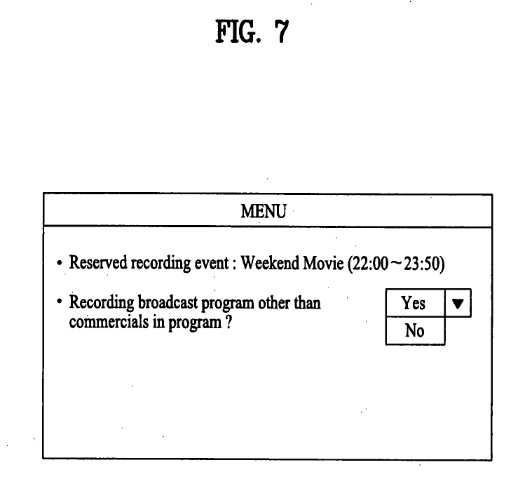

For the convenience of description and better understanding of the present disclosure, it is assumed that the main broadcast program other than the advertisement program inserted into the main broadcast program is recorded in the broadcast receiver by the recording function. In this case, in order to allow the user to establish the above-mentioned recording function, the menu screen image of FIG. 7 may be implemented as necessary. However, it should be noted that the menu screen image of FIG. 7 is disclosed for only illustrative purposes, and can be implemented in the form of other examples as necessary.

If it is determined that the recording function for recording the main broadcast program other than the advertisement program inserted into the main broadcast program has not been established at step S605, the broadcast receiver goes to step S604.

Otherwise, if it is determined that the recording function for recording the main broadcast program other than the advertisement program inserted into the main broadcast program has been established at step S605, the broadcast receiver re-calculates the recording time using information contained in the advertisement_descriptor, and stores only a broadcast part of the main broadcast program at step S606. In this embodiment, the broadcast receiver can employ the start time information or duration information of the advertisement program contained in the advertisement_descriptor.

As apparent from the above description, a DTV receiver and a method for processing a broadcast signal according to the present disclosure have the following effects.

Firstly, the present disclosure can provide a user with advertisement program information configured in the form of an electronic program guide (EPG).

Secondly, the present disclosure can record or exclude only the advertisement program selected by the user, or can record only the main broadcast program other than the advertisement program inserted into the single main broadcast program (i.e., commercial in program or event), such that the user can freely manage the advertisement program according to his or her desired scheme.

Thirdly, if all the advertisement programs located between the main broadcast program and the next main broadcast program are defined as a single event, the present disclosure can increase the operation rapidity of the broadcast receiver and the data transmission efficiency.

It should be noted that most terminology disclosed in the present disclosure is defined in consideration of functions of the present disclosure, and can be differently determined according to intention of those skilled in the art or usual practices. Therefore, it is preferable that the above-mentioned terminology be understood on the basis of all contents disclosed in the present disclosure.

It will be apparant to those skilled in the art that the various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method of processing a digital broadcast signal in a digital television (DTV) receiver, the method comprising:
receiving a broadcast signal which includes an event information table (EIT) that defines at least one advertisement program located between events as a separate event and includes information of the advertisement program and
displaying the information of the advertisement program on a screen.

2. The method of claim 1, further comprising storing each advertisement program using the information of the advertisement program.

3. The method of claim 1, wherein the advertisement program information is defined by a descriptor included in the EIT.

4. The method of claim 1, wherein the advertisement program information includes an information field specifying a start time of each advertisement program.

5. The method of claim 1, wherein the advertisement program includes an information field specifying a duration time of each advertisement program.

6. The method of claim 1, wherein the advertisement program information includes an information field specifying an advertisement type of each advertisement program.

7. The method of claim 6, wherein the advertisement type is genre information of the advertisement.

8. The method of claim 1, wherein the advertisement program information includes an information field specifying additional information of each advertisement program.

9. The method of claim 8, wherein the additional information is a title of the advertisement program or a name of performer who appears in the advertisement program.

10. A method of processing a digital broadcast signal in a digital television (DTV) receiver, the method comprising:
receiving a broadcast signal which includes an event information table (EIT) containing information for an event and information for at least one advertisement program in the middle of the event; and
displaying the information of the advertisement program on a screen.

11. The method of claim 10, further comprising determining whether to store the advertisement in the middle of event using the information of the advertisement program.

12. The method of claim 10, wherein the advertisement program information is defined by a descriptor included in the EIT.

13. The method of claim 10, wherein the advertisement program information includes an information field specifying a start time of each advertisement program.

14. The method of claim 10, wherein the advertisement program includes an information field specifying a duration time of each advertisement program.

15. The method of claim 10, wherein the advertisement program information includes an information field specifying an advertisement type of each advertisement program.

16. The method of claim 10, wherein the advertisement program information includes an information field specifying additional information of each advertisement program.

17. A digital television (DTV) receiver comprising:
a demultiplexer for demultiplexing an event information table (EIT) that defines at least one advertisement program located between events as a separate event and includes information of the advertisement program;
a parser for parsing the demultiplexed information, and decoding the parsed information; and
a controller for controlling the information of the advertisement program to be displayed on a screen.

18. The digital television receiver of claim 17, wherein the controller stores each advertisement program using the information of the advertisement program.

19. The digital television receiver of claim 17, wherein the advertisement program information is defined by a descriptor included in the EIT.

20. The digital television receiver of claim 17, wherein the advertisement program information includes an information field specifying a start time of each advertisement program.

21. The digital television receiver of claim 17, wherein the advertisement program includes an information field specifying a duration time of each advertisement program.

22. The digital television receiver of claim 17, wherein the advertisement program information includes an information field specifying an advertisement type of each advertisement program.

23. The digital television receiver of claim 17, wherein the advertisement program information includes an information field specifying additional information of each advertisement program.

24. A digital television (DTV) receiver comprising:
a demultiplexer for demultiplexing an event information table (EIT) containing information for an event and information for at least one advertisement program in the middle of the event;
a parser for parsing the demultiplexed information, and decoding the parsed information; and
a controller for controlling the information of the advertisement program to be displayed on a screen.

25. The digital television receiver of claim 24, wherein the controller stores each advertisement program using the information of the advertisement program.

26. The digital television receiver of claim 24, wherein the advertisement program information is defined by a descriptor included in the EIT.

27. The digital television receiver of claim 24, wherein the advertisement program information includes an information field specifying a start time of each advertisement program.

28. The digital television receiver of claim 24, wherein the advertisement program includes an information field specifying a duration time of each advertisement program.

29. The digital television receiver of claim 24, wherein the advertisement program information includes an information field specifying an advertisement type of each advertisement program.

30. The digital television receiver of claim 10, wherein the advertisement program information includes an information field specifying additional information of each advertisement program.
